(19) United States
(12) Patent Application Publication
(10) Pub. No.: US 2015/0187506 A1
(43) Pub. Date: Jul. 2, 2015

(54) SOLID ELECTROLYTIC CAPACITOR AND METHOD FOR MANUFACTURING SAME

(71) Applicant: Panasonic Intellectual Property Management Co., Ltd., Osaka (JP)

(72) Inventor: RYO MORIOKA, Aichi (JP)

(21) Appl. No.: 14/659,865

(22) Filed: Mar. 17, 2015

Related U.S. Application Data
(63) Continuation of application No. PCT/JP2013/005632, filed on Sep. 24, 2013.

(30) Foreign Application Priority Data
Sep. 26, 2012 (JP) 2012-212707

(51) Int. Cl. H01G 9/04; H01G 9/00; H01G 9/15

(52) U.S. Cl. CPC H01G 9/04; H01G 9/15; H01G 9/0032; H01G 2009/0412; H01G 2009/0404

(57) ABSTRACT

A solid electrolytic capacitor including: positive electrode; dielectric layer formed on positive electrode; first conductive polymer layer formed on dielectric layer; second conductive polymer layer formed on first conductive polymer layer; and negative electrode layer formed on second conductive polymer layer, wherein insulating particles are scattered between first conductive polymer layer and second conductive polymer layer, and in a region where insulating particles do not exist, second conductive polymer layer is provided directly on first conductive polymer layer.

### RELATED APPLICATIONS

This application is a Continuation of International Application No. PCT/JP2013/005632, filed on Sep. 24, 2013, which in turn claims priority from Japanese Patent Application No. 2012-212707, filed on Sep. 26, 2012, the contents of all of which are incorporated herein by reference in their entireties.

### TECHNICAL FIELD

The present disclosure relates to a solid electrolytic capacitor and a method for manufacturing the solid electrolytic capacitor.

### BACKGROUND

Recently, as electronic equipment has been reduced in size, small-sized high-frequency capacitors having large capacitance have been demanded. As such capacitors, a solid electrolytic capacitor using a solid electrolyte layer made of a conductive polymer has been proposed, which comprises a positive electrode, a dielectric layer, and the solid electrolyte layer that is formed on the dielectric layer. In the solid electrolytic capacitor, the positive electrode is made of a valve metal such as tantalum, niobium, titanium, and aluminum, and then the dielectric layer is formed by anodizing a surface of the positive electrode.

The conductive polymer layer is known to reduce a leak current by changing a part of the conductive polymer layer itself into insulator when an overcurrent occurs (for example, shown in Unexamined Japanese Patent Publication No. 2005-28140). As is proposed in Unexamined Japanese Patent Publication No. 2000-06825 etc., the conductive polymer layer can be formed to be a plurality of layers.

### SUMMARY

A solid electrolytic capacitor according to the present disclosure is a solid electrolytic capacitor including: a positive electrode; a dielectric layer formed on the positive electrode; a first conductive polymer layer formed on the dielectric layer; a second conductive polymer layer formed on the first conductive polymer layer; and a negative electrode layer formed on the second conductive polymer layer, wherein insulating particles are scattered between the first conductive polymer layer and the second conductive polymer layer, and in a region where the insulating particles do not exist, the second conductive polymer layer is provided directly on the first conductive polymer layer.

A method for manufacturing a solid electrolytic capacitor according to the present disclosure includes the steps of: forming a dielectric layer on a positive electrode; forming a first conductive polymer layer on the dielectric layer; scattering and attaching insulating particles on the first conductive polymer layer; forming a second conductive polymer layer on the first conductive polymer layer on which the insulating particles are attached; and forming a negative electrode layer on the second conductive polymer layer.

### BRIEF DESCRIPTION OF DRAWINGS

FIG. 1 is a schematic sectional view of a solid electrolytic capacitor in one exemplary embodiment of the present disclosure.

FIG. 2 is an enlarged schematic sectional view of region a shown in FIG. 1.

### DESCRIPTION OF EMBODIMENT

Problems which exemplary embodiments of this disclosure intend to solve are as follows.

In a solid electrolytic capacitor having a conductive polymer layer comprising a plurality of layers, a leak current cannot be sufficiently reduced. The present disclosure provides a solid electrolytic capacitor having a conductive polymer layer comprising a plurality of layers, which can reduces a leak current.

In the present disclosure, insulating particles are scattered between a first conductive polymer layer and a second conductive polymer layer. Thus, when an overcurrent through the first conductive polymer layer and the second conductive polymer layer occurs, a current does not pass through a region where the insulating particles exist, and a current passes through only a region where the insulating particles do not exist. Thus, the density of a current passing through the first conductive polymer layer and the second conductive polymer layer can be increased, so that insulation of these conductive polymer layers can be accelerated, and therefore a leak current can be reduced.

When the second conductive polymer layer is formed by electrochemical electrolytic polymerization, a current can be concentrated on a region where the insulating particles do not exist, and therefore the current density can be increased, so that the second conductive polymer layer can be densely formed on the first conductive polymer layer. Adhesion between the first conductive polymer layer and the second conductive polymer layer can be thereby improved. Thus, when an overcurrent occurs, not only the first conductive polymer but also the second conductive polymer can be efficiently insulated, so that a leak current can be reduced.

One example of a preferred exemplary embodiment of the present disclosure is described below. It is to be noted that the exemplary embodiment described below is merely illustrative. The present disclosure is not limited to the exemplary embodiment described below.

In the drawings referred to in the exemplary embodiment etc., members having substantially the same functions are provided with the same reference marks. The drawings referred to in the exemplary embodiment etc. are schematically drawn. A ratio among dimensions of an object or the like depicted in the drawing may be different from a ratio among dimensions of an actual object or the like. There may also be difference in dimension ratio or the like of an object between the drawings. A specific dimension ratio or the like of an object should be determined by referring to the following descriptions.

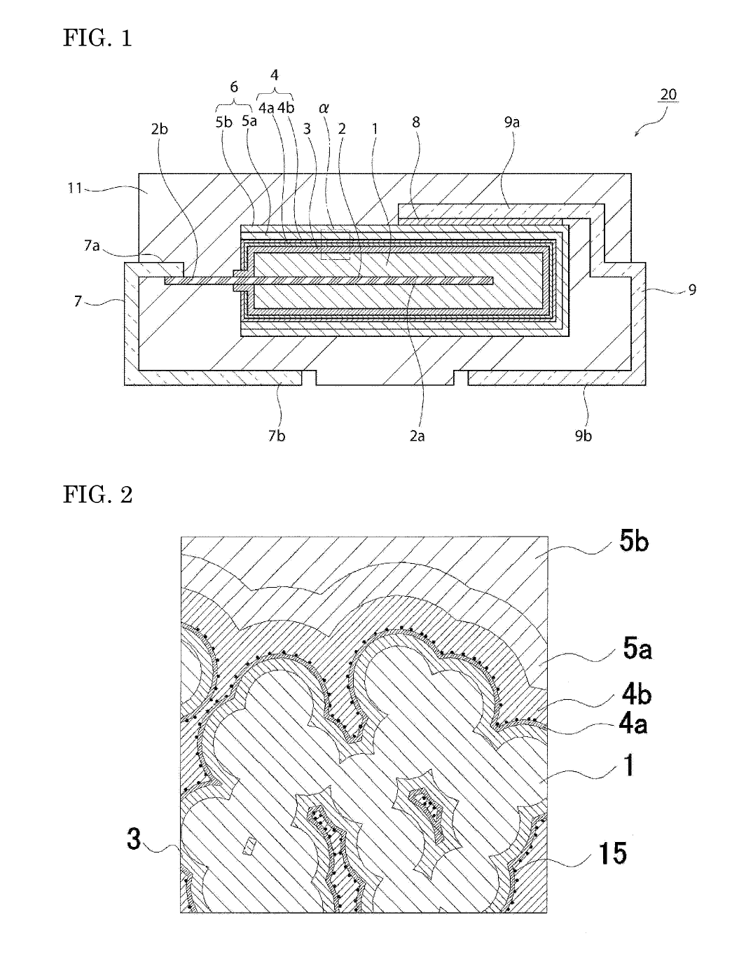

FIG. 1 is a schematic sectional view showing an inner part of a solid electrolytic capacitor according to this exemplary embodiment.

Solid electrolytic capacitor 20 in this exemplary embodiment has a rectangular-parallelepiped shape in external form. As shown in FIG. 1, solid electrolytic capacitor 20 comprises a capacitor element including positive electrode 1, positive electrode lead 2, dielectric layer 3, conductive polymer layer 4 and negative electrode layer 6; positive electrode terminal 7; negative electrode terminal 9; and resin outer body 11. These components are described below.

The capacitor element includes positive electrode 1 made of a valve metal; positive electrode lead 2 provided so that one end part 2a is embedded in positive electrode 1 and other end part 2b protrudes from positive electrode 1; dielectric layer 3 formed by anodizing positive electrode 1; conductive polymer layer 4 formed on dielectric layer 3; and negative electrode layer 6 formed on conductive polymer layer 4. In this exemplary embodiment, conductive polymer layer 4 comprises first conductive polymer layer 4a, and second conductive polymer layer 4b formed on first conductive polymer layer 4a. Negative electrode layer 6 includes carbon layer 5a and silver paste layer 5b.

Positive electrode 1 is made of a porous body formed by molding a large number of metal particles of a valve metal or an alloy thereof, and sintering the metal particles. Examples of the valve metal are tantalum, niobium, titanium and aluminum. Examples of the alloy are alloys of these valve metals, and the alloy may contain, for example, silicon, vanadium, boron, nitrogen and the like.

Positive electrode lead 2 is bonded to positive electrode 1 with one end part 2a embedded in positive electrode 1.

Positive electrode lead 2 is made of a valve metal or an alloy thereof similarly to positive electrode 1. The metal or alloy of positive electrode lead 2 may be same as or different from the metal or alloy of positive electrode 1.

Dielectric layer 3 can be formed so as to cover a surface of positive electrode 1 by anodizing positive electrode 1. FIG. 1 illustrates dielectric layer 3 made of an oxide film formed on an outer surface of positive electrode 1, but since positive electrode 1 is a porous body as described above, actually dielectric layer 3 is also formed on wall surfaces of pores of the porous body.

Conductive polymer layer 4 is formed on dielectric layer 3. In this exemplary embodiment, conductive polymer layer 4 comprises first conductive polymer layer 4a and second conductive polymer layer 4b as described above. In this exemplary embodiment, insulating particles are provided between first conductive polymer layer 4a and second conductive polymer layer 4b. In FIG. 1, insulating particles are not illustrated. The insulating particles are described later with reference to FIG. 2. Negative electrode layer 6 is formed on conductive polymer layer 4.

Negative electrode layer 6 has a laminated structure in which carbon layer 5a and silver paste layer 5b are sequentially formed. Carbon layer 5a is formed from a layer containing carbon particles. Silver paste layer 5b formed on carbon layer 5a is formed from a layer containing silver particles. Negative electrode layer 6 may be formed from only one of carbon layer 5a and silver paste layer 5b. Negative electrode layer 6 may be constituted from a layer having a current collecting function.

FIG. 2 is an enlarged schematic sectional view of region a shown in FIG. 1. As shown in FIG. 2, positive electrode 1 is a porous body, and dielectric layer 3 is also formed on surfaces of pores of the porous body.

As shown in FIG. 2, first conductive polymer layer 4a is formed on dielectric layer 3. On first conductive polymer layer 4a, insulating particles 15 are provided so as to be scattered. Second conductive polymer layer 4b is provided on first conductive polymer layer 4a and insulating particles 15. Insulating particles 15 are provided so as to be scattered between first conductive polymer layer 4a and second conductive polymer layer 4b.

Since positive electrode 1 is a porous body as described above, first conductive polymer layer 4a, insulating particles 15 and second conductive polymer layer 4b are also provided on dielectric layer 3 on surfaces of pores of the porous body.

Examples of insulating particles 15 are those of metal oxides such as titanium oxide (TiO₂), silicon oxide (SiO₂), zirconium oxide (ZrO), zinc oxide (ZnO) and aluminum oxide (Al₂O₃). Particles of these metal oxides are relatively inexpensive and easily available. However, insulating particles 15 in the present disclosure are not limited to the above-mentioned particles. The method for attaching insulating particles 15 on first conductive polymer layer 4a is, for example, a method in which a solution containing insulating particles 15 is brought into contact with a surface of first conductive polymer layer 4a, and then insulating particles 15 are attached on first conductive polymer layer 4a by removing a solvent in the solution, as will be described later. Therefore, insulating particles 15 are preferably insulating particles dispersible in a solution.

The average particle size of insulating particles 15 is preferably a size that allows the particles to easily enter pores of the porous body. From this point of view, the average particle size of insulating particles 15 is preferably in a range of 1 nm to 100 nm. The positive electrode in the present disclosure is not limited to a porous sintered body as in this exemplary embodiment, and may be, for example, a foil made of a valve metal or an alloy. When the positive electrode is a foil, the average particle size of insulating particles 15 is preferably an average particle size that allows the particles to easily enter etching pits of the foil. Insulating particles 15 that are easily disposed on surfaces of pores of the porous body or in etching pits of the foil are preferably nanoparticles having an average particle size in a range of 1 nm to 20 nm.

Examples of the method for measuring the average particle size of insulating particles 15 are a measurement using a scanning microscope, and a measurement using a photon correlation method, a laser diffraction/scattering method or an ultrasonic attenuation method for a dispersion liquid of insulating particles 15 dispersed in a solution.

As conductive polymers to be used for first conductive polymer layer 4a and second conductive polymer layer 4b, polypyrrole, polythiophene, polyaniline, polyacetylene, polyethylene vinylidene, polyfluorene, polycarbazole, polyvinyl phenol, polyphenylene, polypyridine, and derivatives and copolymers thereof can be used. Particularly, polypyrrole, polythiophene and polyaniline are suitably used because they are easily formed on dielectric layer 3 and have high conductivity, and as polythiophene, poly-3,4-ethylenedioxythiophene is suitably used.

In this exemplary embodiment, first conductive polymer layer 4a is formed by a chemical oxidation polymerization method. Second conductive polymer layer 4b is formed by electrochemical electrolytic polymerization. The conductive polymer to be used for second conductive polymer layer 4b may be made of a material same as or different from the material of the conductive polymer to be used for first conductive polymer layer 4a.

A step of forming first conductive polymer layer 4a, a step of attaching insulating particles 15 and a step of forming second conductive polymer layer 4b are described below.

(Step of Forming First Conductive Polymer Layer 4a)

First conductive polymer layer 4a is formed by chemical oxidation polymerization in the following manner: positive electrode 1 with dielectric layer 3 formed on a surface thereof is immersed in a solution containing an oxidant and then immersed in a solution containing a monomer, or immersed in a solution containing an oxidant and a monomer. Alternatively, positive electrode 1 may be immersed in a solution containing an oxidant, and then exposed to vapor containing a monomer, thereby performing chemical oxidation polymerization to form first conductive polymer layer 4a. A dopant can be contained in any one of the solutions. As another method, a solution with a conductive polymer such as polyaniline dissolved therein may be applied to dielectric layer 3 and dried to form the conductive polymer layer, or a solution containing a dispersion of a conductive polymer may be applied to dielectric layer 3 and dried to form the conductive polymer layer.

### (Step of Attaching Insulating Particles 15)

Insulating particles 15 can be attached on first conductive polymer layer 4a by immersing positive electrode 1, on which first conductive polymer layer 4a is formed, in an aqueous solution with insulating particles 15 dispersed therein, and drying positive electrode 1. The aqueous solution is not limited as long as insulating particles 15 can be dispersed in the aqueous solution. Positive electrode 1 on which insulating particles 15 are attached may be appropriately washed with water and dried.

(Step of Forming Second Conductive Polymer Layer 4b)

Positive electrode 1 with first conductive polymer layer 4a and insulating particles 15 sequentially provided on dielectric layer 3 is impregnated with a solution containing a monomer and a dopant, and the monomer is polymerized by electrochemical electrolytic polymerization to form second conductive polymer layer 4b. As another method, a solution with a conductive polymer such as polyaniline dissolved therein may be applied and dried to form second conductive polymer layer 4b, or a solution containing a dispersion of a conductive polymer may be applied and dried to form second conductive polymer layer 4b.

As described above, by providing insulating particles 15 between first conductive polymer layer 4a and second conductive polymer layer 4b, when an overcurrent occurs, the overcurrent can be concentrated on a region which is not provided with insulating particles 15, so that the density of a current passing through first conductive polymer layer 4a and second conductive polymer layer 4b can be increased. Thus, insulation of first conductive polymer layer 4a and second conductive polymer layer 4b can be accelerated, so that a leak current can be reduced.

In formation of second conductive polymer layer 4b by electrochemical electrolytic polymerization, a current for electrolytic polymerization can be concentrated on a region which is not provided with insulating particles 15. Therefore, second conductive polymer layer 4b can be densely formed, so that adhesion between first conductive polymer layer 4a and second conductive polymer layer 4b can be improved. Thus, when an overcurrent occurs, not only first conductive polymer layer 4a but also second conductive polymer layer 4b can be efficiently insulated, so that a leak current can be reduced.

When insulating particles 15 can enter surfaces of pores of the porous body or surfaces of pores of the etching pits, the above-mentioned effect can also be exerted at the surfaces of pores of the porous body or the surfaces of pores of the etching pits, so that adhesion between first conductive polymer layer 4a and second conductive polymer layer 4b can be improved. Thus, a leak current can be further reduced.

The conductive polymer has high conductivity by a dopant captured in a chain formed by polymerization of a monomer. Therefore, it is considered that a cation is generated at a part where the dopant is not bonded to the polymer chain. When insulating particles 15 have a negative charge, insulating particles 15 are easily disposed on a surface of first conductive polymer layer 4a because they are attracted to cations of first conductive polymer layer 4a. Further, cations of second conductive polymer layer 4b and insulating particles 15 are bonded together, so that adhesion between first conductive polymer layer 4a and second conductive polymer layer 4b can be improved.

Polymerized polypyrrole and polyaniline are formed in an oxidized state that has partially lost electrons. Usually, for giving high conductivity to a polymerized polymer with developed 7-conjugated systems, an anionic dopant (acceptor) is captured in a cation part that has partially lost electrons. When insulating particles 15 are negatively charged, insulating particles 15 are attracted to cations of first conductive polymer layer 4a because they are negatively charged in a dispersion liquid, so that insulating particles 15 are easily disposed on a surface of first conductive polymer layer 4a. Further, the cation part of second conductive polymer layer 4b and insulating particles 15 are captured, so that adhesion between first conductive polymer layer 4a and second conductive polymer layer 4b can be improved.

When insulating particles 15 are nanoparticles of a metal oxide, surfaces of insulating particles 15 are easily negatively charged.

It is preferred that insulating particles 15 are made of titanium oxide because particles of titanium oxide are inexpensive and easily available as compared to particles of other metal oxides, and have high stability to acidic and alkaline solutions and are chemically stable.

Insulating particles 15 may be partially aggregated. When insulating particles 15 are partially aggregated, adhesion between first conductive polymer layer 4a and second conductive polymer layer 4b can be improved.

In this exemplary embodiment, first conductive polymer layer 4a is a layer formed by chemical oxidation polymerization, and second conductive polymer layer 4b is a layer formed by electrochemical electrolytic polymerization. Delamination more easily occurs between conductive polymer layers formed by different production processes. In this exemplary embodiment, insulating particles 15 are provided between first conductive polymer layer 4a and second conductive polymer layer 4b, and therefore even when first conductive polymer layer 4a and second conductive polymer layer 4b are formed by different production processes, proper adhesion can be obtained.

Referring back to FIG. 1, positive electrode terminal 7, negative electrode terminal 9 and resin outer body 11 are described.

Positive electrode terminal 7 is attached to positive electrode lead 2. Specifically, positive electrode terminal 7 is formed by bending a belt-shaped metal plate, and as shown in FIG. 1, a lower surface of positive electrode terminal 7 on the one end part 7a is mechanically and electrically connected to other end part 2b of the positive electrode lead by welding or the like.

Negative electrode terminal 9 is attached to negative electrode layer 6. Specifically, negative electrode terminal 9 is formed by bending a belt-shaped metal plate, and as shown in FIG. 1, a lower surface of negative electrode terminal 9 on the one end part 9a is bonded to negative electrode layer 6 by conductive adhesive 8, so that negative electrode terminal 9 and negative electrode layer 6 are mechanically and electrically connected to each other. Specific examples of the material of conductive adhesive 8 include materials such as a silver paste formed by mixing silver and an epoxy resin.

Examples of the material of positive electrode terminal 7 and negative electrode terminal 9 are copper, a copper alloy and an iron-nickel alloy (42 alloy).

Resin outer body 11 is formed so as to cover exposed surfaces of positive electrode lead 2, negative electrode layer 6, positive electrode terminal 7 and negative electrode terminal 9. Other end part 7b of positive electrode terminal 7 and other end part 9b of negative electrode terminal 9 are exposed from a side surface to a lower surface of resin outer body 11, and the exposed portions are used for solder connection with a substrate.

For resin outer body 11, a material that serves as a sealing material is used, and specific examples are an epoxy resin and a silicone resin.

In the exemplary embodiment, the positive electrode has been described with a porous sintered body taken as an example, but the positive electrode body in the present disclosure is not limited thereto, and may be a foil made of a valve metal or an alloy as described above.

In this exemplary embodiment, conductive polymer layer 4 including two layers: first conductive polymer layer 4a and second conductive polymer layer 4b has been described as an example, but the present disclosure is not limited thereto, and the conductive polymer layer may have a laminated structure of three or more layers. In this case, insulating particles should be provided between at least two conductive polymer layers.

### EXAMPLES

The present disclosure will be described further in detail below by way of an example, but the present disclosure is not limited to the example below.

### Example 1

### Step 1: Formation of Positive Electrode

With use of tantalum metal particles having a primary particle size of about 0.5 μm and a secondary particle size of about 100 μm, a plurality of tantalum metal particles were molded with one end part 2a of positive electrode lead 2 being embedded in positive electrode 1, and the tantalum metal particles were sintered in vacuum to mold positive electrode 1 made of a porous sintered body. Other end part 2b of positive electrode lead 2 made of tantalum is fixed in such a manner as to protrude from one surface of positive electrode 1. The outer shape of formed positive electrode 1 made of a porous sintered body is a rectangular parallelepiped shape having a length of 4.4 mm, a width of 3.3 mm and a thickness of 0.9 mm.

### Step 2: Formation of Dielectric Layer

Other end part 2b of positive electrode lead 2 is connected to an positive electrode of an anodizing bath, positive electrode 1 and a part of positive electrode lead 2 are immersed in the anodizing bath containing 0.01 to 0.1% by mass of an aqueous phosphoric acid solution as an electrolytic aqueous solution, and anodization is performed to form dielectric layer 3 of tantalum oxide (Ta₂O₅) on a surface of positive electrode 1 and a part of a surface of positive electrode lead 2. Through this anodization step, homogeneous dielectric layer 3 is formed on an outer surface, i.e. the surface of positive electrode 1 made of a porous sintered body, wall surfaces of pores and a part of positive electrode lead 2.

The electrolytic aqueous solution is not limited to an aqueous phosphoric acid solution, and nitric acid, acetic acid, sulfuric acid or the like can be used.

### Step 3: Formation of First Conductive Polymer

First conductive polymer layer 4a made of polypyrrole is formed on a surface of dielectric layer 3 using a chemical polymerization method.

### Step 4: Attachment of Insulating Particles

A surface of first conductive polymer layer 4a is immersed in an aqueous solution with insulating particles 15 dispersed therein, thereby attaching insulating particles 15 on the surface. Titanium oxide particles (average particle size: 5 nm to 10 nm) were used as insulating particles 15.

### Step 5: Formation of Second Conductive Polymer Layer

A second conductive polymer layer is formed so as to cover a surface of first conductive polymer layer 4a, which is exposed from insulating particles 15, and insulating particles 15. Second conductive polymer layer 4b was made of polypyrrole, and formed by electrochemical electrolytic polymerization.

### Step 6: Formation of Negative Electrode Layer

Carbon layer 5a was formed by applying a carbon paste so that the carbon paste was in direct contact with a surface of conductive polymer layer 4, and silver paste layer 5b was formed by applying a silver paste onto carbon layer 5a. In this example, negative electrode layer 6 comprises carbon layer 5a and silver paste layer 5b, but negative electrode layer 6 is not limited as long as it is a layer having a current collecting function.

In the manner described above, the capacitor element according to Example 1 was formed.

### Comparative Example 1

A capacitor element of Comparative Example 1 was prepared in the same manner as in Example 1 except that insulating particles 15 were not provided on first conductive polymer layer 4a in Example 1.

### (Results)

In the capacitor elements according to Example 1 and Comparative Example 1, a leak current and an equivalent series resistance (ESR) were measured. For the leak current, a voltage of 10 V was applied between electrodes, and a leak current after 40 seconds was measured. The equivalent series resistance (ESR) was measured at 100 kHz.

The measurement results are listed in Table 1. Values in Table 1 are obtained by relativizing the comparative example with values in Example 1 set to 1.

TABLE 1

| | Leak current | ESR |
|---|---|---|
| Example 1 | 1.00 | 1.00 |
| Comparative Example 1 | 1.42 | 1.04 |

It is evident from the results shown in Table 1 that in Example 1 according to the present disclosure, the leak current is reduced as compared to Comparative Example 1. The ESR in Example 1 is supposed to be high because insulating particles 15 are provided between first conductive polymer layer 4a and second conductive polymer layer 4b, but actually the ESR in Example 1 is slightly lower than that in Comparative Example 1. This is considered to be because adhesion between first conductive polymer layer 4a and second conductive polymer layer 4b was improved.

What is claimed is:

1. A solid electrolytic capacitor comprising: a positive electrode; a dielectric layer formed on the positive electrode; a first conductive polymer layer formed on the dielectric layer; a second conductive polymer layer formed on the first conductive polymer layer; and a negative electrode layer formed on the second conductive polymer layer, wherein
insulating particles are scattered between the first conductive polymer layer and the second conductive polymer layer, and in a region where the insulating particles do not exist, the second conductive polymer layer is provided directly on the first conductive polymer layer.

2. The solid electrolytic capacitor according to claim 1, wherein the insulating particles are made of titanium oxide.

3. The solid electrolytic capacitor according to claim 1, wherein the first conductive polymer layer is a layer formed by chemical oxidation polymerization, and the second conductive polymer layer is a layer formed by electrochemical electrolytic polymerization.

4. A method for manufacturing a solid electrolytic capacitor, the method comprising the steps of:
forming a dielectric layer on a positive electrode;
forming a first conductive polymer layer on the dielectric layer;
scattering and attaching insulating particles on the first conductive polymer layer;
forming a second conductive polymer layer on the first conductive polymer layer on which the insulating particles are attached; and
forming a negative electrode layer on the second conductive polymer layer.

5. The method for manufacturing a solid electrolytic capacitor according to claim 4, wherein a solution containing the insulating particles is applied on the first conductive polymer layer, and then the insulating particles are attached on the first conductive polymer layer by removing a solvent of the solution.

6. The method for manufacturing a solid electrolytic capacitor according to claim 5, wherein the insulating particles have a charge in the solution.

7. The method for manufacturing a solid electrolytic capacitor according to claim 4, wherein the second conductive polymer layer is formed by electrochemical electrolytic polymerization.
